(19) United States
(12) Patent Application Publication
(10) Pub. No.: US 2014/0146134 A1
(43) Pub. Date: May 29, 2014

(54) METHOD AND SYSTEM FOR ENCODING 3D VIDEO

(71) Applicant: INDUSTRIAL TECHNOLOGY RESEARCH INSTITUTE, Hsinchu (TW)

(72) Inventors: Jih-Sheng Tu, Yilan County (TW); Jung-Yang Kao, Pingtung County (TW)

(73) Assignee: Industrial Technology Research Institute, Hsinchu (TW)

(21) Appl. No.: 13/762,362

(22) Filed: Feb. 8, 2013

(30) Foreign Application Priority Data
Nov. 23, 2012 (TW) 101143960

(51) Int. Cl. H04N 13/00

(52) U.S. Cl. CPC H04N 13/0048
USPC 348/43

(57) ABSTRACT

A method and system for encoding three-dimensional (3D) video are provided. The method includes: obtaining a depth map of the 3D video, wherein the depth map includes multiple pixels and each of the pixels has a depth value; identifying a first contour of an object in the depth map; changing the depth values according to whether the pixels are located on the first contour to generate a contour bit map; compressing the contour bit map to generate a first bit stream, and decompressing the first bit stream to generate a reconstructed contour bit map; obtaining multiple sampling pixels of the pixels in the object according to a second contour corresponding to the object in the reconstructed contour bit map; and, encoding locations and the depth values of the sampling pixels. Therefore, a compression ratio of the 3D video is increased.

### CROSS-REFERENCE TO RELATED APPLICATION

This application claims the priority benefit of Taiwan application serial no. 101143960, filed on Nov. 23, 2012. The entirety of the above-mentioned patent application is hereby incorporated by reference herein and made a part of this specification.

### BACKGROUND

1. Technical Field

The disclosure relates to an encoding method. Particularly, the disclosure relates to a method for encoding a three-dimensional (3D) video and a system for encoding the 3D video.

2. Related Art

A three-dimensional (3D) image is composed of images of different viewing angles. When a left eye and a right eye respectively view images of different viewing angles, the human brain may automatically synthesize a 3D image.

FIG. 1 is a system schematic diagram of a 3D display.

Referring to FIG. 1, regarding a certain scene, the 3D display 110 displays pixel values corresponding to each of viewing angles V1-V9. The right eye of a user 121 can view pixel values of the viewing angle V1, and the left eye of the user 121 can view pixel values of the viewing angle V2. In this way, the user 121 can view a 3D video. On the other hand, a user 122 may view pixel values of the viewing angles V8 and V9 to obtain another 3D video. Therefore, the user 121 and the user 122 can view 3D images of different viewing angles. Generally, pixel values corresponding to different viewing angles can be generated through a texture image (color image) and a depth map (gray level image). In FIG. 1, a texture image 141 belongs to the viewing angle V1, a texture image 142 belongs to the viewing angle V5, and a texture image 143 belongs to the viewing angle V9. On the other hand, a depth map 151 corresponds to the texture image 141, a depth map 152 corresponds to the texture image 142, and a depth map 153 corresponds to the texture image 143. A synthesizer can simulate pixel values of the viewing angles V2-V4 according to the texture images 141-142 and the depth maps 151-152, and the synthesizer can also simulate pixel values of the viewing angles V6-V8 according to the texture images 142-143 and the depth maps 152-153.

A general video compressing algorithm (for example, H.264) can be used to compress the texture image. However, how to compress the depth maps may be an important issue concerned by related technicians.

### SUMMARY

The disclosure is directed to a method for encoding a three-dimensional (3D) video and a system for encoding a 3D video, which are used to encode the 3D video and a depth map therein.

An exemplary embodiment of the disclosure provides a method for encoding a 3D video, which is adapted to a video encoding apparatus. The method for encoding 3D video includes following steps. A depth map of the 3D video is obtained, wherein the depth map includes a plurality of pixels and each of the pixels has a depth value. A first contour of an object in the depth map is identified. The depth values are changed to generate a contour bit map according to whether the pixels are located on the first contour. The contour bit map is compressed to generate a first bit stream, and the first bit stream is decompressed to generate a reconstructed contour bit map. A plurality of sampling pixels of the pixels in the object are obtained according to a second contour corresponding to the object in the reconstructed contour bit map. Locations and the depth values of the sampling pixels are encoded.

According to another aspect, an exemplary embodiment of the disclosure provides a system for encoding a three-dimensional (3D) video including a depth estimation module, a contour estimation module, a bit map generation module, a compression module, a decompression module, a sampling module and an entropy encoding module. The depth estimation module is used to obtain a depth map of the 3D video. The depth map includes a plurality of pixels, and each of the pixels has a depth value. The contour estimation module is coupled to the depth estimation module, and identifies a first contour of an object in the depth map. The bit map generation module is coupled to the contour estimation module, and changes the depth values to generate a contour bit map according to whether the pixels are located on the first contour. The compression module is coupled to the bit map generation module, and compresses the contour bit map to generate a first bit stream. The decompression module is coupled to the compression module, and decompresses the first bit stream to generate a reconstructed contour bit map. The sampling module is coupled to the depth estimation module and the decompression module, and obtains a plurality of sampling pixels of the pixels in the object according to a second contour corresponding to the object in the reconstructed contour bit map. The entropy encoding module is coupled to the sampling module, and encodes locations and the depth values of the sampling pixels.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a system schematic diagram of a three-dimensional (3D) display.

FIG. 2 is a schematic diagram of a 3D video encoding system according to an exemplary embodiment of the disclosure.

FIG. 3 and FIG. 4 are schematic diagrams of a depth map according to an exemplary embodiment of the disclosure.

FIG. 5 is a flowchart illustrating a method of generating a contour bit map according to an exemplary embodiment of the disclosure.

FIG. 6 is a schematic diagram of a reconstructed contour bit map according to an exemplary embodiment of the disclosure.

FIG. 7 is a schematic diagram of obtaining sampling pixels according to an exemplary embodiment of the disclosure.

FIG. 8 is a schematic diagram of encoding and decoding a 3D video according to an exemplary embodiment of the disclosure.

FIG. 9 is a flowchart illustrating a method for encoding a 3D video according to an exemplary embodiment of the disclosure.

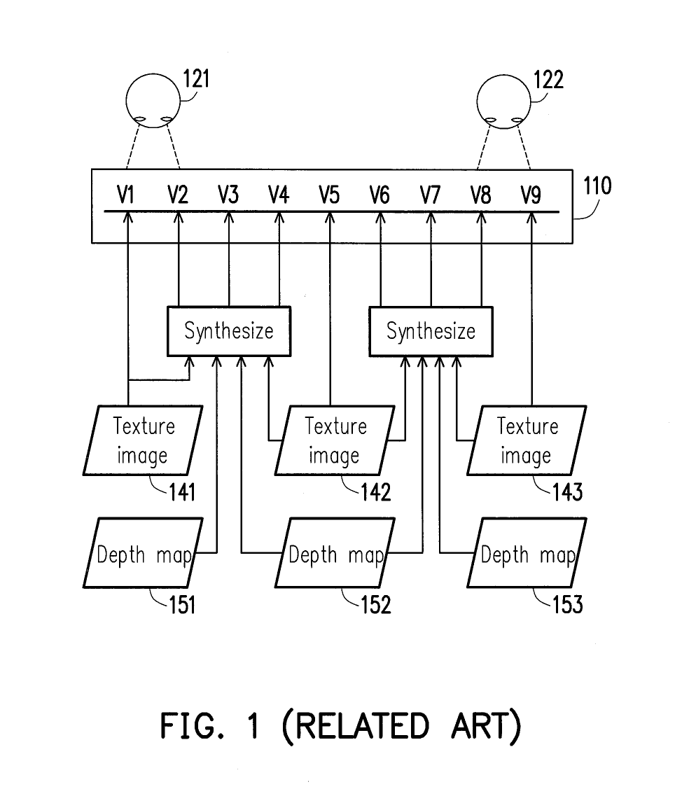

### DETAILED DESCRIPTION OF DISCLOSED EMBODIMENTS

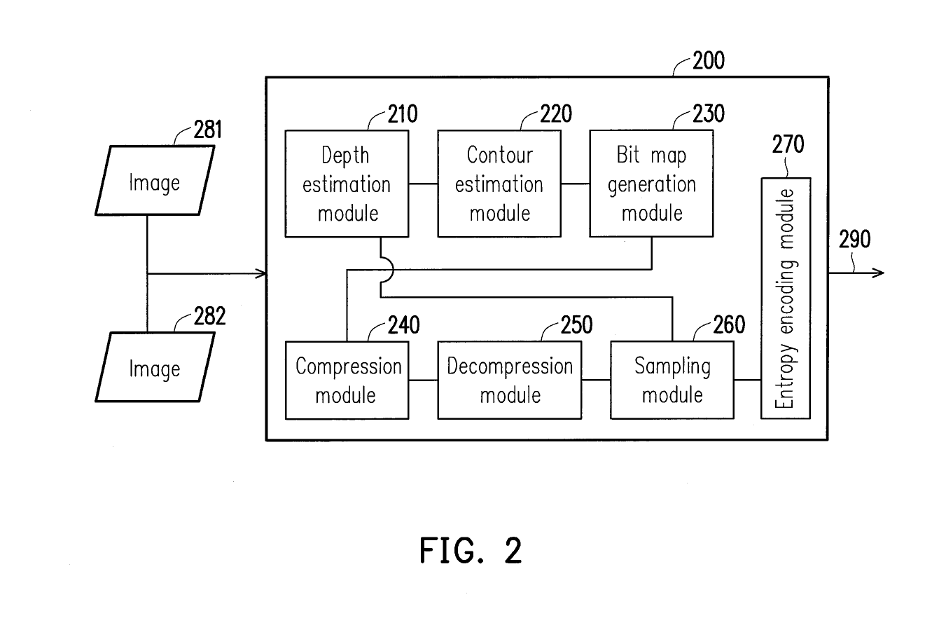

FIG. 2 is a schematic diagram of a three-dimensional (3D) video encoding system according to an exemplary embodiment of the disclosure.

Referring to FIG. 2, the 3D video encoding system 200 includes a depth estimation module 210, a contour estimation module 220, a bit map generation module 230, a compression module 240, a decompression module 250, a sampling module 260 and an entropy encoding module 270. The 3D video encoding system 200 receives an image 281 and an image 282, where the image 281 and the image 282 belong to different viewing angles. The 3D video encoding system 200 generates a bit stream 290 for representing a clip of 3D video.

The depth estimation module 210 is used to obtain a depth map of the 3D video generated according to the image 281 and the image 282. The depth map includes a plurality of pixels, and each of the pixels has at least one depth value. The contour estimation module 220 is coupled to the depth estimation module 210, and identifies an object and a contour of the object in the depth map. Since one object generally has similar depths, depth values in the object are similar to each other. The bit map generation module 230 is coupled to the contour estimation module 220, and changes the depth values of the pixels to generate a contour bit map according to whether the pixels are located on the contour. The compression module 240 is coupled to the bit map generation module 230, and compresses the contour bit map to generate a first bit stream. The decompression module 250 is coupled to the compression module 240, and decompresses the first bit stream to generate a reconstructed contour bit map. The sampling module 260 is coupled to the depth estimation module 210 and the decompression module 250, and obtains a plurality of sampling pixels of the pixels in the object according to a contour corresponding to the object in the reconstructed contour bit map. The entropy encoding module 270 is coupled to the sampling module 260, and encodes locations and the depth values of the sampling pixels to generate a second bit stream. Moreover, the compression module 240 can also encode one texture image (for example, the image 281 or the image 282), and generates a third bit stream. In the present exemplary embodiment, the first bit stream, the second bit stream and the third bit stream form the bit stream 290, which represents a clip of 3D video. Moreover, the 3D video encoding system 200 can also generate the bit stream 290 according to images of more viewing angles, which is not limited by the disclosure.

In an exemplary embodiment, the 3D video encoding system 200 is implemented by software, namely, each of the modules in the 3D video encoding system 200 includes a plurality of instructions, and the instructions are stored in a memory. A processor can execute the above instructions to generate the bit stream 290. However, in an exemplary embodiment, the 3D video encoding system 200 is implemented by hardware, namely, each of the modules in the 3D video encoding system 200 is implemented by one or a plurality of circuits, and the 3D video encoding system 200 can be configured on an electronic apparatus. Implementation of the 3D video encoding system 200 through software or hardware is not limited by the disclosure.

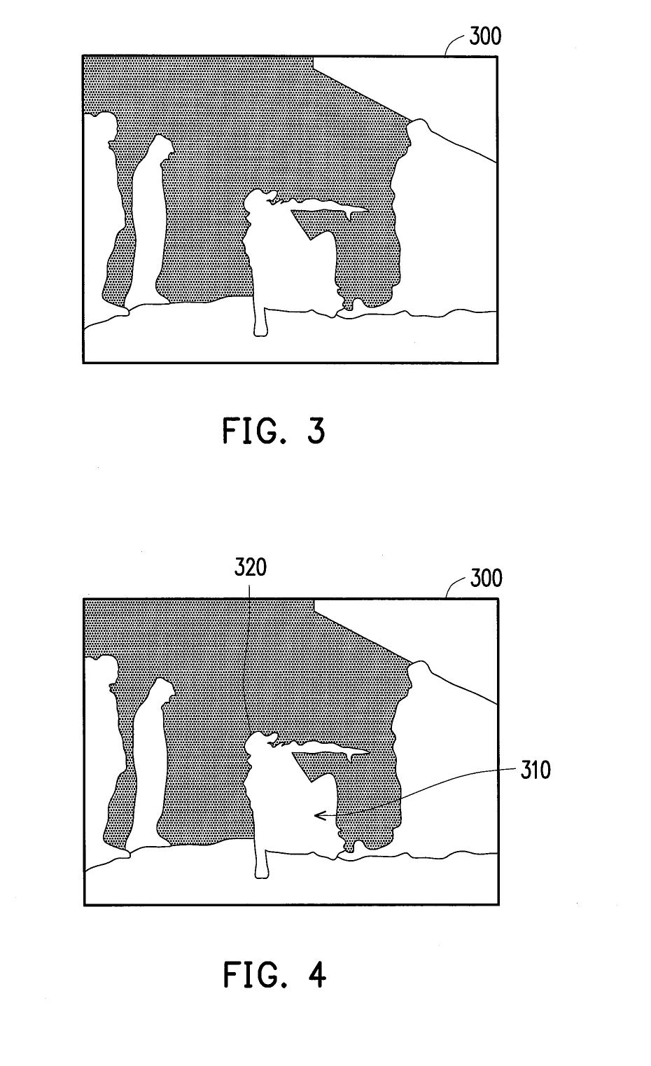

FIG. 3 and FIG. 4 are schematic diagrams of a depth map according to an exemplary embodiment of the disclosure.

Referring to FIG. 3, for example, the depth estimation module 210 executes an algorithm to obtain a depth map 300, each position in the depth map 300 corresponds to a pixel, and each pixel includes at least one depth value. In an exemplary embodiment, the smaller the depth value of a region is (a shading region in FIG. 3), the further such region is away from a camera. The depth estimation module 210 may obtain the depth map 300 according to any algorithm, which is not limited by the disclosure. For example, the depth estimation module 210 obtains paired feature points in two images, and generates the depth values according to the feature points, where the feature points refers to a pixel point of the image 281 and a paired point (for example, a certain point with the closest color) on a same horizontal line in the image 282. When a disparity between the pixel point and the paired point is relatively large, it represents that the pixel point is closer to a lens, and when the disparity is relatively small, it represents that the pixel point is relatively far away from the lens. The depth values can be calculated according to magnitudes of the disparities and other parameters of the camera, though the disclosure is not limited thereto.

Referring to FIG. 4, the contour estimation module 220 identifies a contour of an object in the depth map 300. For example, the contour estimation module 220 executes an algorithm such as edge detection, object partition or clustering, etc. to obtain an object 310 and a contour 320 of the object 310. The object 310 is taken as an example for descriptions, though the contour estimation module 220 can also identify more objects, which is not limited by the disclosure.

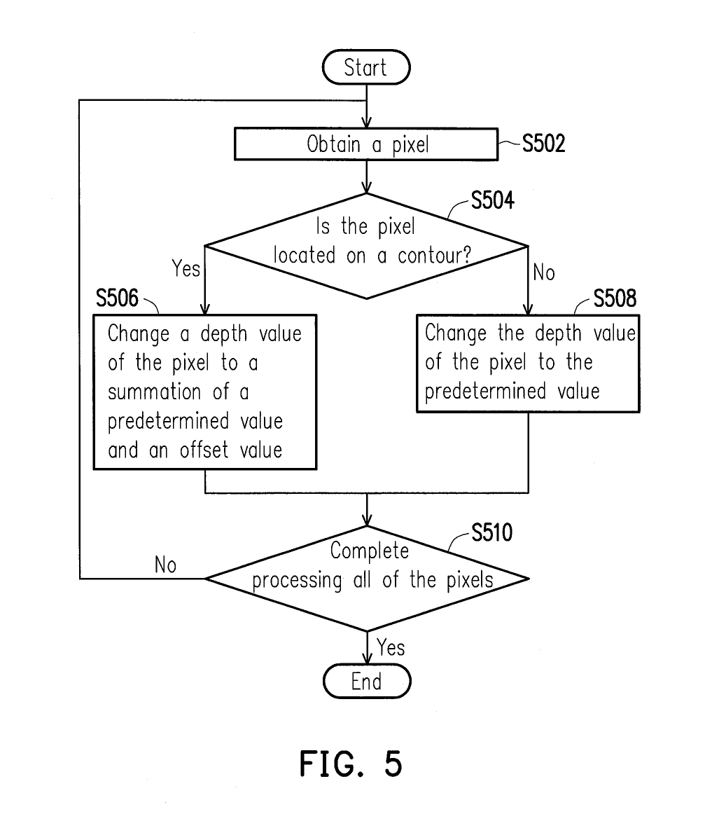

The bit map generation module 230 changes the depth value of a pixel to generate a contour bit map according to whether the pixel is located on the contour 320. For example, referring to FIG. 5, FIG. 5 is a flowchart illustrating a method of generating a contour bit map according to an exemplary embodiment of the disclosure. In step S502, the bit map generation module 230 obtains a pixel in the depth map 300. In step S504, the bit map generation module 230 determines whether the pixel is located on the contour 320. If yes, in step S506, the bit map generation module 230 changes the depth value of the pixel to a summation of a predetermined value and an offset value. If not, in step S508, the bit map generation module 230 changes the depth value of the pixel to the predetermined value. Then, in step S510, the bit map generation module 230 determines whether all of the pixels have been processed. If a determination result of the step S510 is affirmative, the bit map generation module 230 ends the flow, and if not, the bit map generation module 230 returns to the step S502 to continually process a next pixel. In an exemplary embodiment, the predetermined value is 128, and the offset value is an integer other than 0. Therefore, after various steps of FIG. 5 are executed, the contour bit map only has two types of values. However, in other exemplary embodiment, the predetermined value and the offset value can be other values, which is not limited by the disclosure.

In an exemplary embodiment, the compression module 240 compresses the contour bit map to generate a first bit stream by using a video compression algorithm. The video compression algorithm includes a spatial-frequency transformation and a quantization operation. For example, the video compression algorithm is an H.264 compression algorithm, or a high efficiency video coding (HEVC) algorithm. In other exemplary embodiments, the compression module 240 can also compress the contour bit map in a pattern of binary string. For example, the compression module 240 marks a contour part as a bit “1”, and marks a non-contour part as a bit “0”, so as to form a binary string. Then, the compression module 240 encodes the binary string by using a variable length coding (VLC) algorithm or a binary arithmetic coding (BAC) algorithm, so as to compress the contour bit map, though the disclosure is not limited thereto.

It should be noticed that since the contour bit map has only two types of values, and all of the depth values in a same object are the same (i.e. the predetermined value), a compression ratio of the contour bit map is enhanced. In an exemplary embodiment, the bit map generation module 230 can set the offset value according to a bit rate of the 3D video, and the offset value is inversely proportional to the bit rate. In detail, the higher the bit rate is, the lower a quantization parameter (QP) is, so that even if the offset value is set to a very small value, it is not easy to generate distortion. Conversely, the lower the bit rate is, the higher the QP is, and the offset value has to be set to a larger value, so that two different values in the contour bit map are not quantized into a same value.

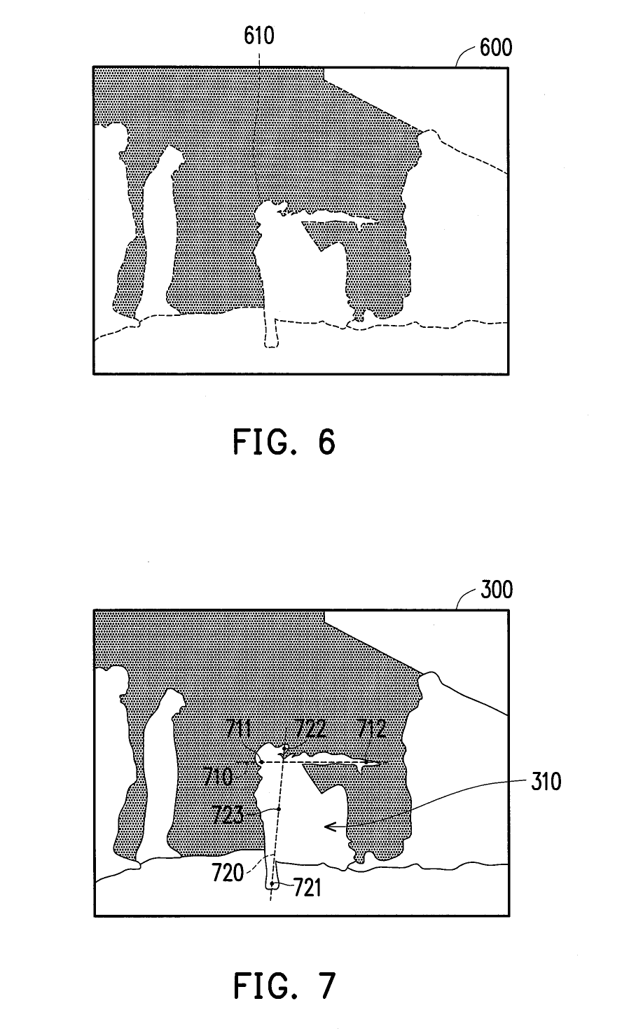

After the compression module 240 compresses the contour bit map and generates the firs bit stream, the first bit stream is sent to a decoding end. In order to synchronize the decoding end and the 3D video encoding system 200, the decompression module 250 decompresses the first bit stream to generate a reconstructed contour bit map. However, since the compression module 240 generates the first bit stream according to the video compression algorithm, the reconstructed contour bit map is not totally the same to the contour bit map. Referring to FIG. 6, FIG. 6 is a schematic diagram of a reconstructed contour bit map according to an exemplary embodiment of the disclosure. A contour 610 in the reconstructed contour bit map 600 corresponds to the object 310 and is broken and discontinuous. Therefore, the decompression module 250 repairs the contour 610, such that the contour 610 may have a closing region. For example, the decompression module 250 performs a binarization operation, a line detection operation and a line thinning operation to the reconstructed contour bit map 600. However in other exemplary embodiments, the decompression module 250 can also repair the contour 610 by using other algorithms, which is not limited by the disclosure.

FIG. 7 is a schematic diagram of obtaining sampling pixels according to an exemplary embodiment of the disclosure.

Referring to FIG. 6 and FIG. 7, the sampling module 260 obtains a plurality of sampling pixels of the pixels in the object 310 according to the contour 610 of the reconstructed contour bit map 600. In an exemplary embodiment, the sampling module 260 obtains depth values of a plurality of pixels along one direction in the object 310. If the depth values along the direction are monotonically increased or monotonically decreased, the sampling module 260 obtains at least two endpoint pixels along such direction to serve as the sampling pixels. If the depth values along such direction are not monotonically increased or monotonically decreased (i.e. including two variations of increasing and decreasing), the sampling module 260 obtains at least two endpoint pixels and at least one middle pixel in the pixels of the object along such direction to serve as the sampling pixels. For example, the sampling module 260 obtains pixels values of a plurality of pixels along a direction 710, and it is assumed that the depth values along such direction 710 are monotonically increased. Therefore, the sampling module 260 sets the two endpoint pixels 711 and 712 along the direction 710 as the sampling pixels. The endpoint pixels 711 and 712 are respectively a leftmost pixel and a rightmost pixel along the direction 710. On the other hand, the sampling module 260 obtains depth values along a direction 720, and it is assumed that the depth values along such direction 720 are not monotonically increased or monotonically decreased (which are, for example, first decreased and then increased). Therefore, the sampling module 260 obtains two endpoint pixels 721 and 722 and a middle pixel 723 along the direction 720 as the sampling pixels. The endpoint pixels 721 and 722 are respectively an uppermost pixel and a lowermost pixel along the direction 721. The depth value of the middle pixel 723 is a maximum or minimum depth value in all of the depth values along the direction 720. However, in other exemplary embodiments, the sampling module 260 can obtain sampling pixels from other directions, and can also obtain more number of the middle pixel to serve as the sampling pixels, which is not limited by the disclosure.

After the sampling pixels are obtained, the entropy encoding module encodes locations and the depth values of the sampling pixels to generate a second bit stream. The second bit stream is transmitted to a decoding end, and the decoding end reconstructs the locations and the depth values of the sampling pixels. On the other hand, the decoding end also obtains the reconstructed contour bit map. The decoding end obtains all of the depth values in the object 310 through interpolation according to the reconstructed contour bit map and the sampling pixels. In an exemplary embodiment, the decoding end obtains depth values of the pixels other than the sampling pixels through linear interpolation. However, the decoding end can also calculate a polynomial function or an exponential function according to the locations and the depth values of the sampling pixels, and calculate the other depth values according to the polynomial function or the exponential function.

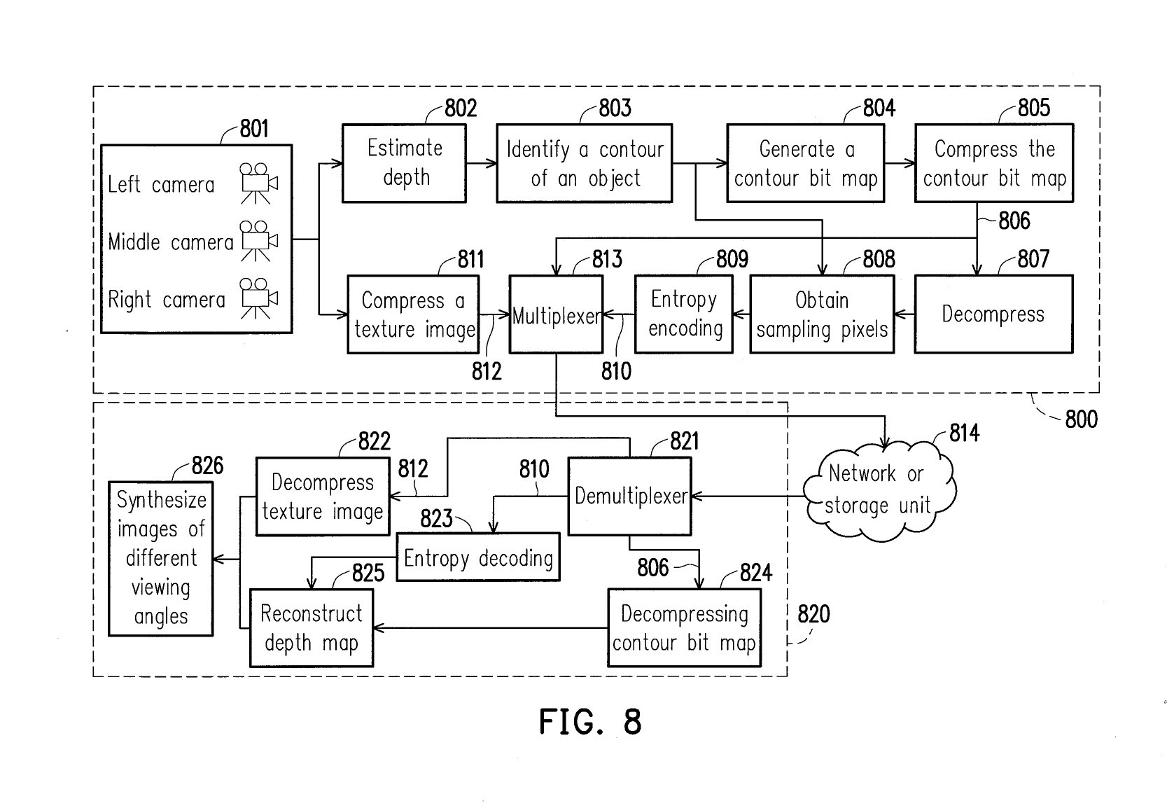

FIG. 8 is a schematic diagram of encoding and decoding a 3D video according to an exemplary embodiment of the disclosure.

Referring to FIG. 8, in a compression process 800, a 3D video 801 is captured by cameras through a plurality of viewing angles (for example, a left camera, a middle camera and a right camera are used). A depth of a certain viewing angle in the 3D video 801 is estimated (step 802) to generate a depth map. In step 803, a contour of an object in the depth map is identified. In step 804, a contour bit map is generated according to the identified contour. In step S805, the contour bit map is compressed to generate a first bit stream 806. In step S807, the first bit stream 806 is decompressed to generate a reconstructed contour bit map. In step 808, sampling pixels are obtained according to the depth map and the reconstructed contour bit map. In step 809, entropy coding is performed to encode locations and the depth values of the sampling pixels to generate a second bit stream 810. On the other hand, in step 811, a texture image in the 3D video 801 is compressed to generate a third bit stream 812. A multiplexer 813 generates a fourth bit stream representing the 3D video 801 according to the first bit stream 806, the second bit stream 810 and the third bit stream 812, and transmits the same to a network or a storage unit 814.

In a decoding process 820, a demultiplexer 821 obtains the fourth bit stream from the network or the storage unit 814, and decodes to obtain the first bit stream 806, the second bit stream 810 and the third bit stream 812. In step 822, the texture image is decompressed according to the third bit stream 812. In step 823, entropy decoding is performed to the second bit stream 810 to obtain the locations and the depth map of the sampling pixels. In step 824, the contour bit map is decompressed according to the first bit stream 806. In step 825, the depth values in the object are obtained through interpolation according to the contour bit map and the sampling pixel, so as to reconstruct the depth map. In step 826, images of different viewing angles are synthesized according to the texture image and the depth map.

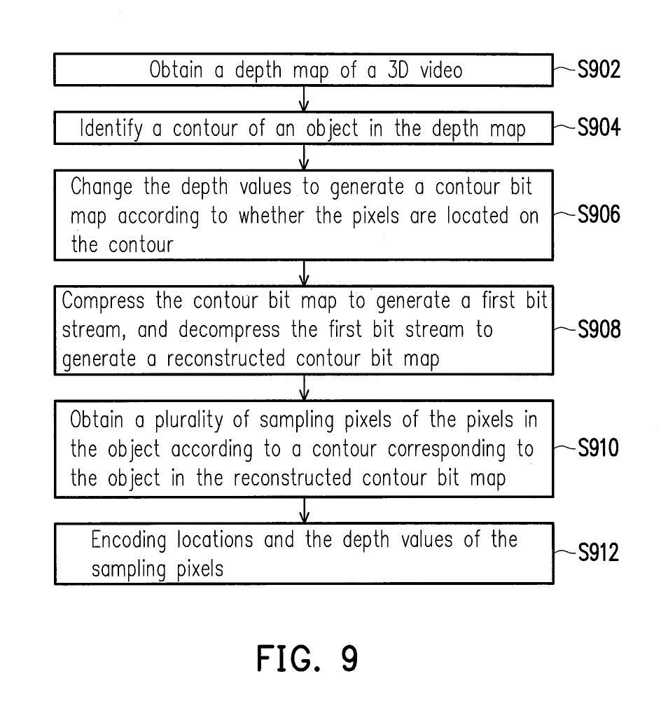

FIG. 9 is a flowchart illustrating a method for encoding a 3D video according to an exemplary embodiment of the disclosure.

Referring to FIG. 9, in step S902, a depth map of the 3D video is obtained. In step S904, a contour of an object in the depth map is identified. In step S906, the depth values are changed to generate a contour bit map according to whether the pixels are located on the contour. In step S908, the contour bit map is compressed to generate a first bit stream, and the first bit stream is decompressed to generate a reconstructed contour bit map. In step S910, a plurality of sampling pixels of the pixels in the object are obtained according to a contour corresponding to the object in the reconstructed contour bit map. In step S912, locations and the depth values of the sampling pixels are encoded. Various steps of FIG. 9 have been described in detail above, which are not repeated. It should be noticed that the method for encoding the 3D video can be applied to a video encoding apparatus, and the video encoding apparatus can be implemented as a personal computer (PC), a notebook computer, a server, a smart phone, a tablet PC, a digital camera or any type of embedded system, which is not limited by the disclosure.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for encoding a three-dimensional (3D) video, adapted to a video encoding apparatus, and the method for encoding the 3D video comprising:
obtaining a depth map of the 3D video, wherein the depth map comprises a plurality of pixels and each of the pixels has a depth value;
identifying a first contour of an object in the depth map;
changing the depth values to generate a contour bit map according to whether each of the pixels is located on the first contour;
compressing the contour bit map to generate a first bit stream, and decompressing the first bit stream to generate a reconstructed contour bit map;
obtaining a plurality of sampling pixels of the pixels in the object according to a second contour corresponding to the object in the reconstructed contour bit map; and
encoding a location and the depth value of each of the sampling pixels.

2. The method for encoding the 3D video as claimed in claim 1, wherein the step of changing the depth values to generate the contour bit map according to whether each of the pixels is located on the first contour comprises:
if a first pixel in the pixels is located on the first contour, changing the depth value of the first pixel to a summation of a predetermined value and an offset value; and
changing the depth value of the first pixel to the predetermined value if the first pixel is not located on the first contour.

3. The method for encoding the 3D video as claimed in claim 2, wherein the offset value is inversely proportional to a bit rate of the 3D video.

4. The method for encoding the 3D video as claimed in claim 1, wherein the step of decompressing the first bit stream to generate the reconstructed contour bit map comprises:
repairing the second contour, so that the second contour has a closing region.

5. The method for encoding the 3D video as claimed in claim 1, wherein the step of obtaining the sampling pixels in the object of the depth map according to the reconstructed contour bit map comprises:
obtaining a plurality of second depth values in the object along a direction;
obtaining at least two endpoint pixels in the object along the direction to serve as the sampling pixels if the second depth values are monotonically increased or monotonically decreased; and
obtaining the at least two endpoint pixels and at least one middle pixel in the object along the direction to serve as the sampling pixels if the second depth values are not monotonically increased or monotonically decreased.

6. The method for encoding the 3D video as claimed in claim 5, further comprising:
obtaining the depth values in the object through interpolation according to the sampling pixels and the second contour.

7. The method for encoding the 3D video as claimed in claim 1, wherein the step of compressing the contour bit map to generate the first bit stream comprises:
compressing the contour bit map to generate the first bit stream by using a video compression algorithm, wherein the video compression algorithm comprises a spatial-frequency transformation and a quantization operation.

8. A system for encoding a three-dimensional (3D) video, comprising:
a depth estimation module, obtaining a depth map of the 3D video, wherein the depth map comprises a plurality of pixels, and each of the pixels has a depth value;
a contour estimation module, coupled to the depth estimation module, and identifying a first contour of an object in the depth map;
a bit map generation module, coupled to the contour estimation module, and changing the depth values to generate a contour bit map according to whether each of the pixels is located on the first contour;
a compression module, coupled to the bit map generation module, and compressing the contour bit map to generate a first bit stream;
a decompression module, coupled to the compression module, and decompressing the first bit stream to generate a reconstructed contour bit map;
a sampling module, coupled to the depth estimation module and the decompression module, and obtaining a plurality of sampling pixels of the pixels in the object according to a second contour corresponding to the object in the reconstructed contour bit map; and
an entropy encoding module, coupled to the sampling module, and encoding a location and the depth value of each of the sampling pixels.

9. The system for encoding the 3D video as claimed in claim 8, wherein if a first pixel in the pixels is located on the first contour, the bit map generation module changes the depth value of the first pixel to a summation of a predetermined value and an offset value,
if the first pixel is not located on the first contour, the bit map generation module changes the depth value of the first pixel to the predetermined value.

10. The system for encoding the 3D video as claimed in claim 9, wherein the offset value is inversely proportional to a bit rate of the 3D video.

11. The system for encoding the 3D video as claimed in claim 8, wherein the decompression module further repairs the second contour, so that the second contour has a closing region.

12. The system for encoding the 3D video as claimed in claim 8, wherein the sampling module further obtains a plurality of second depth values in the object along a direction,
if the second depth values are monotonically increased or monotonically decreased, the sampling module obtains at least two endpoint pixels in the object along the direction to serve as the sampling pixels, and
if the second depth values are not monotonically increased or monotonically decreased, the sampling module obtains the at least two endpoint pixels and at least one middle pixel in the object along the direction to serve as the sampling pixels.

13. The system for encoding the 3D video as claimed in claim 8, wherein the decompression module compresses the contour bit map to generate the first bit stream by using a video compression algorithm, wherein the video compression algorithm comprises a spatial-frequency transformation and a quantization operation.
